(19) United States
(12) Patent Application Publication
(10) Pub. No.: US 2023/0002163 A1
(43) Pub. Date: Jan. 5, 2023

(54) STONE PAVER AND HEAVY OBJECT LIFTING APPARATUS

(71) Applicant: Michael Oliphant, Ivins, UT (US)

(72) Inventor: Michael Oliphant, Ivins, UT (US)

(21) Appl. No.: 17/810,508

(22) Filed: Jul. 1, 2022

Related U.S. Application Data
(60) Provisional application No. 63/217,669, filed on Jul. 1, 2021.

(51) Int. Cl. B65G 7/12; E01C 19/52

(52) U.S. Cl. CPC B65G 7/12; E01C 19/526

(57) ABSTRACT

A lifting apparatus has a handle and a scissor grip. The scissor grip is actuated by pushing the handle downward or by lifting it upward. Each end of the scissor grip comprises a bracket for coupling to opposing edges of an object to be lifted. As the handle is raised, the scissor grip actuates, squeezing and holding the object between the brackets. Alternatively, in some embodiments, as the handle is raised, the scissor grip may actuate, expanding and exerting outward force and thus holding an object from an interior. A user may then easily transport the object to the desired location, place the object without bending, and may release the object from the scissor grip by pressing downward on the handle and pivoting it to release at least one bracket from the side of the object.

### CROSS-REFERENCE TO RELATED APPLICATIONS

This application claims priority to U.S. Provisional Application Ser. No. 63/217,669, filed Jul. 1, 2021, which is incorporated herein by reference.

### TECHNICAL FIELD

The present disclosure relates to lifting heavy objects, such as paver stones. More particularly, the present disclosure relates to an apparatus for lifting and moving heavy objects.

### BACKGROUND

Pavers are frequently used to build walkways, patios, driveways, and other surfaces. They are often chosen over poured concrete for their customizable look, durability, and ease of repair. Pavers may also come in a variety of sizes, from brick-shaped pavers to tile-shaped pavers, and may be made from stone, concrete, or other materials. Regardless of the paver used, moving and placing the pavers is a tedious task that is time-consuming and may often lead to injury. In particular, a user must frequently bend over to grasp a tile to then transport it or otherwise move it into position. The frequent bending and strain can have serious consequences for a user's back, particularly when moving and placing numerous, heavy pavers.

In addition, pavers are also difficult to grasp for lifting and are tricky to place, with fingers often getting pinched between adjacent pavers. Many users, in an effort to avoid pinched fingers, use their feet to push a paver into place after placing it near an adjacent stone in a pathway. However, this is not ideal as it can change the surface under the pavers, making them uneven.

Attempts have been made to make the transportation and placement of pavers easier. However, the devices in the prior art still require a user to bend over to couple or release the paver from the device.

In addition to pavers, there are numerous heavy objects that are difficult and/or awkward for a user to lift and transport. From wire spools and pipes to railroad ties and concrete sections, there is a need for a device that allows a user to easily lift and maneuver heavy objects without bending over and without risking injury to fingers. The lifting apparatus disclosed herein solves these problems and others.

### SUMMARY OF EXAMPLE EMBODIMENTS

In some embodiments, a lifting apparatus comprises a semi-rigid, spring handle (e.g., metal tubing with memory) and a scissor grip. Due to the spring nature of the handle, the scissor grip is actuated by pushing the handle downward or by lifting it upward. Each end of the scissor grip comprises a bracket for coupling to opposing edges of a heavy object. As the handle is lifted, the scissor grip actuates, squeezing and holding the object between the brackets. A user may then easily transport the object to the desired location, place the object without bending over, and may release the object from the scissor grip by pressing downward on the springing handle, thereby widening and loosening the brackets, allowing a user to pivot the lifting apparatus to release the object from the brackets.

In some embodiments, the handle may comprise a coil spring to aid in maintaining its default position. In some embodiments, the scissor grips are actuated using a separate lever, which may or may not require a spring.

In some embodiments, the size and configuration of the handle may vary for the intended use. Further, in some embodiments, the handle and/or scissor grips are extendable (e.g., telescopic) in length.

In some embodiments, the width, length, and form factor of the brackets may vary to be complementary to the form of heavy objects such as pipes, lumbar, railroad ties, and I-beams.

In some embodiments, the brackets have a first side, a second side, and a third side, wherein the third side further comprises prongs, spikes, or serrated edges for gripping heavy objects.

In some embodiments, the lifting apparatus comprises a handle having a first end hingedly coupled to a first arm, and a second end hingedly coupled to a second arm. The first arm may further comprise a first telescoping extension arm and the second arm may further comprise a second telescoping arm. The first telescoping arm can be received in a first end or second, opposite end of the first arm. Likewise, the second telescoping end can be received in a first end or second, opposite end of the second arm. In a first configuration, the lifting apparatus grips an outer edge of an object and in a second configuration, the lifting apparatus grips an inner surface or edge of an object.

### BRIEF DESCRIPTION OF THE DRAWINGS

FIG. 1 illustrates a front perspective view of a lifting apparatus with the scissor grips in a first, gripping position lifting a paver stone;

FIG. 2 illustrates a bottom, rear elevation view of a lifting apparatus with the scissor grips in a second, open position;

FIG. 3 illustrates a front elevation view of a lifting apparatus with the scissor grips in a first, gripping position;

FIG. 4 illustrates a top, front perspective view of a lifting apparatus with the scissor grips in a second, open position;

FIG. 5 illustrates a top plan view of a lifting apparatus;

FIG. 6 illustrates a front perspective view of a lifting apparatus lifting a spool;

FIG. 7 illustrates a bottom, rear elevation view of a lifting apparatus with the scissor grips in a second, open position;

FIG. 8 illustrates a front elevation view of a lifting apparatus with the scissor grips in a second configuration for lifting hollow objects;

FIG. 9 illustrates a front perspective view of a lifting apparatus comprising a spring with the scissor grips in a first, gripping position;

FIG. 10 illustrates a front, bottom perspective view of a lifting apparatus with a handle of a second configuration with the scissor grips in an open position;

FIG. 11 illustrates a front, bottom perspective view of a lifting apparatus with a handle of a second configuration with the scissor grips in a closed, gripping position;

FIG. 12 is a top perspective view of a lifting apparatus with a handle of a second configuration in a second, open position;

FIG. 13 is a top plan view of a lifting apparatus with a handle of a second configuration;

FIG. 14 illustrates a front perspective view of a user lifting a section of concrete with a lifting apparatus with a handle of a second configuration in a first, gripping position; and

FIG. 15 illustrates a front perspective view of a user lifting a section of concrete with a lifting apparatus with a handle of a second configuration in a first, gripping position.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As discussed earlier, there is a need to easily lift, move, and place a heavy object without bending over and without risking pinching fingers or other injury. The lifting apparatus disclosed herein seeks to solve these and other problems. While stone pavers are used as an example, the invention is not so limited, and the lifting apparatus may be used with a variety of heavy objects.

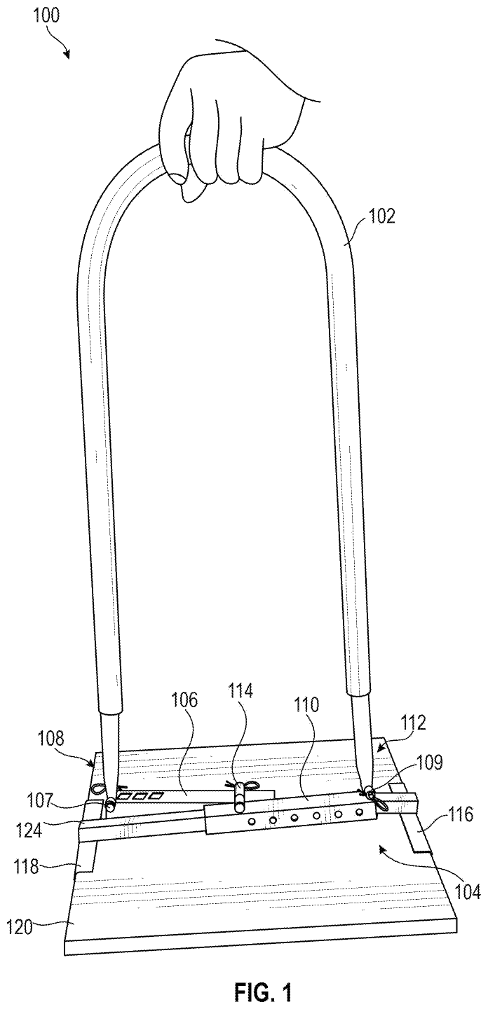

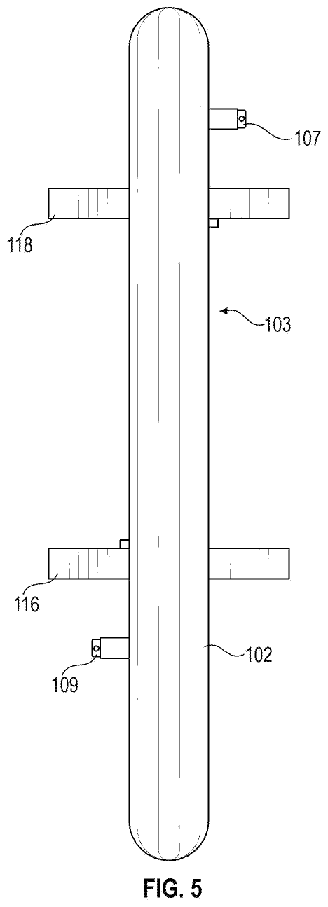

In some embodiments, as shown in FIGS. 1-8, a lifting apparatus 100 comprises a semi-rigid, springing U-shaped handle 102 (also referred to simply as handle 102) and a scissor grip 104. The handle 102 is, preferably, manufactured from materials that are sufficiently stiff, yet elastic (e.g., tubular metals) such that the handle 102 will return to a default, pre-configured position after flexing by a user. In other words, the handle 102 allows for elastic deformation, but returns to its original state when force is not applied to it (i.e., memory). Due to the elastic nature of the handle 102, the scissor grip 104 is actuated by pushing the handle 102 downward or by lifting it upward, as will be discussed later herein. In some embodiments, the scissor grip 104 comprises a first arm 106 hingedly coupled to a first end 108 of the handle 102, such as by a first hinge pin 107, and a second arm 110 hingedly coupled to a second end 112 of the handle 102, such as by a second hinge pin 109. The first arm 106 is pivotally coupled to the second arm 110 at a center hinge pin 114. Further, the first arm 106 comprises a first bracket 116 and the second arm 110 comprises a second bracket 118.

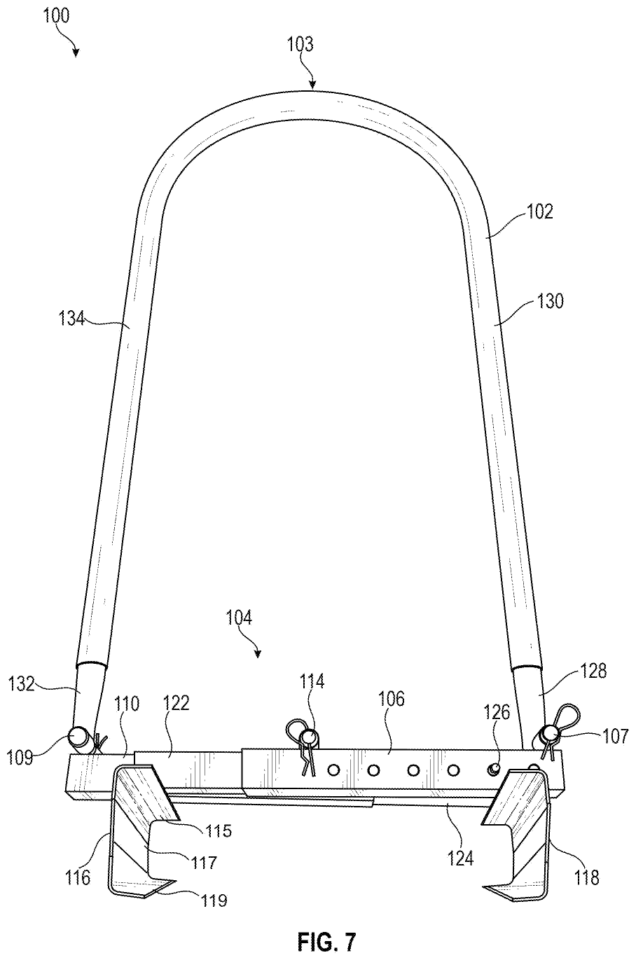

In some embodiments, as shown in FIG. 7, the first bracket 116 and the second bracket 118 each comprise a first side 115, a second side 117, and a third side 119. The third side may further comprise prongs, spikes, a rubberized end, or other edges to aid in gripping objects. Further, the first bracket 116 and second bracket 118 may comprise a formfactor that is complementary to the shape of objects such as pipes, lumbar, railroad tiles, and I-beams. For example, the brackets may be rounded and concave (e.g., half-pipe shaped) for gripping a pipe.

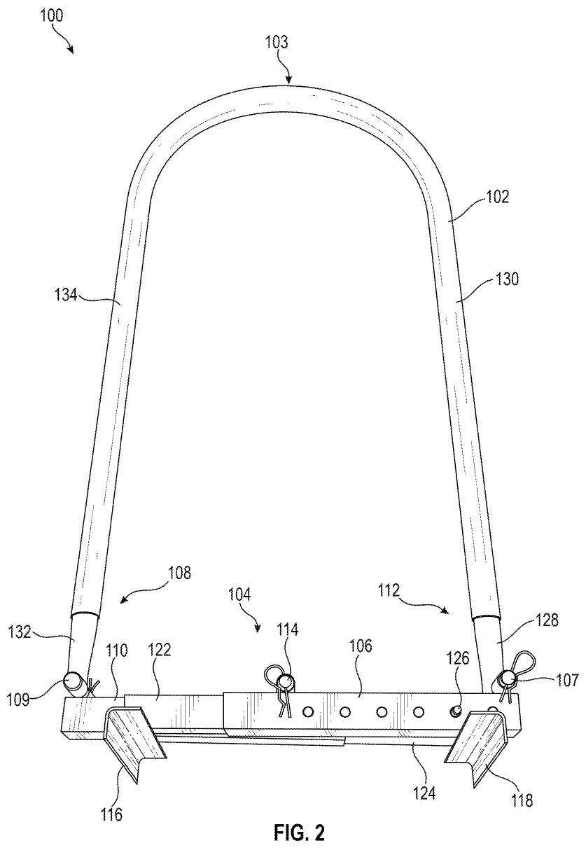

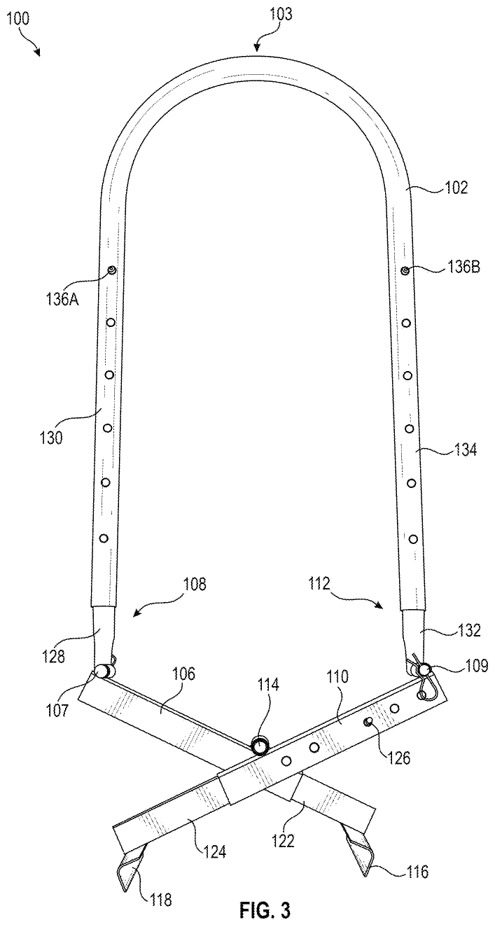

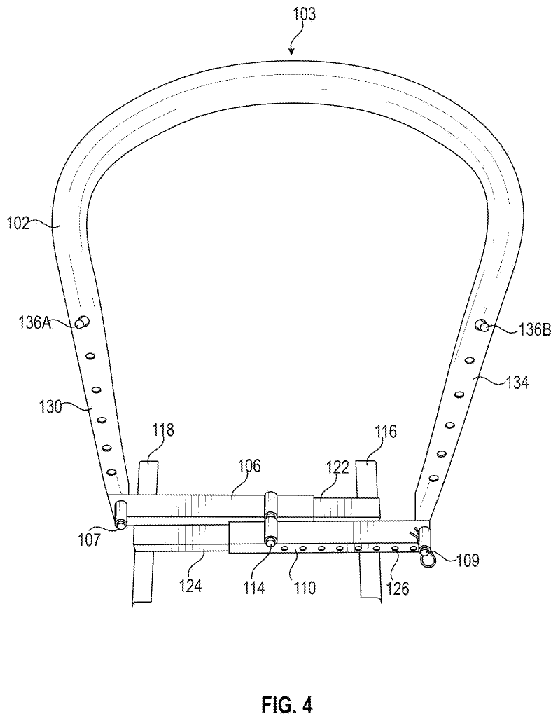

Referring to FIG. 3, in its default position (due to the springing handle 102), the first end 108 and the second end 112 of the handle 102 are separated from each other by a first distance. In this position, the scissor grip 104 is in a “cross” configuration such that the first bracket 116 and second bracket 118 are also separated by a first distance (a “gripping” position). Due to the elasticity of the handle 102, the handle 102 will assume this position when lifted by a user or when no downward force is applied on the handle 102. It will be appreciated that in some embodiments, the weight of the handle 102 alone is enough to overcome the spring and cause the arms 106, 110 to be parallel to each other and extend longitudinally in the same horizontal plane, as shown in FIGS. 2 and 4. Additionally, FIGS. 2 and 4 show an open position, with the first end 108 and second end 112 of the handle 102 separated by a second distance, the second distance being greater than the first distance. The brackets 116, 118 are also separated by a second distance, greater than the first, and are therefore capable of extending over the edges of an object to be lifted.

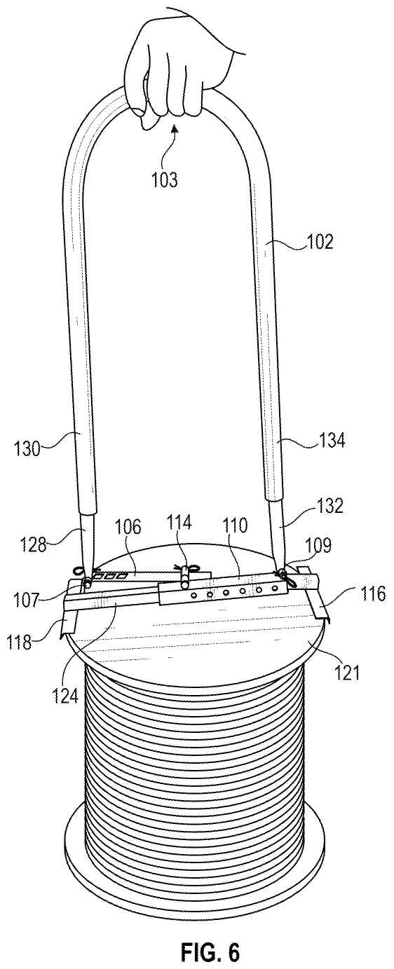

Therefore, as understood, the scissor grip 104 actuates so that the first bracket 116 and second bracket 118 move closer to one another (to a distance less than the second distance), squeezing and holding (i.e., gripping) an object therebetween (e.g., paver 120 as shown in FIG. 1, spool 121 as shown in FIG. 6, or other objects). A user may then easily transport the object (e.g., paver 120) to the desired location and place the object without bending over. To release the object from the grip of the first and second bracket 116, 118, a user presses downward on the top 103 of the handle 102, forcing the first end 108 and the second end 112 downward, which causes the first arm 106 and the second arm 110 to actuate in relation to one another at the center hinge pin 114, with the first arm 106 and second arm 110 being positioned in substantially the same horizontal plane, as shown in FIG. 2, when fully actuated. In this position, the first end 108 and second end 112 are at a second distance from each other, the second distance being wider than the first distance, as mentioned above. Likewise, the first bracket 116 and second bracket 118 are at a second distance from each other, the second distance being greater than the first. As a result of the increased distance between the brackets 116, 118, the grip loosens, thereby allowing a user to release the object, such as paver 120, by pivoting the handle 102 to release at least one bracket 116, 118 from the object.

Objects may vary in overall length/size. Accordingly, the first arm 106 and/or second arm 110 may be length adjustable, such as by telescoping. For example, the first arm 106 may have a telescoping extension arm 122 and second arm 110 may have a telescoping extension arm 124. The telescoping extension arms 122, 124 may be secured at the desired position using spring-loaded pins 126, set screws, locking pins, rack and gear, or any other known mechanisms for extending and retracting the length of the arms 106, 110. This allows a user to customize the lifting apparatus 100 for a variety of objects and object sizes. While shown with telescoping extensions 122, 124, they are not required. However, when they are incorporated, it will be appreciated that the brackets 116, 118 are coupled to the end of each extension 122, 124, respectively.

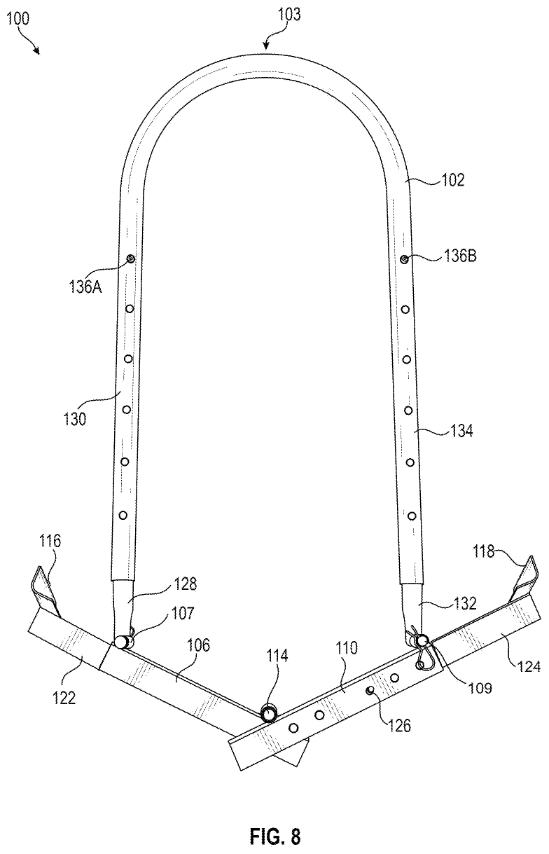

Furthermore, it will be appreciated that the telescoping extension arms 122, 124 may be received in either end of the first arm 106 and the second arm 110, and may be secured at the desired position using spring-loaded pins 126, set screws, locking pins, rack and gear, or any other known mechanisms for extending and retracting the length of the arms 106, 110. For example, as shown in FIG. 8, the telescoping extension arms 122, 124 may be received near the first hinge pin 107 and the second hinge pin 109, respectively. In this embodiment, the lifting apparatus 100 may be inserted within hollow spaces of objects such that when the lifting apparatus 100 is lifted upward and the brackets 116, 118 engage an inner surface or lip of the object, the scissor grip 104 actuates so that the first bracket 116 and second bracket 118 move farther apart from one another, exerting outward force on the object, thereby allowing a user to lift the object, such as a pot. Moreover, the first bracket 116 and the second bracket 118 may be configured to conform to an inner lip or edge within the hollow interior space of a heavy object such as a pot.

Additionally, the handle 102 may vary in overall length, such as by being telescopic. For example, a first handle extension 128 may extend on a first side 130 and a second handle extension 132 may extend on a second side 134. Each of the extensions may be secured at the desired position using spring-loaded pins 136A-B or other mechanisms known in the art of pole/leg extensions.

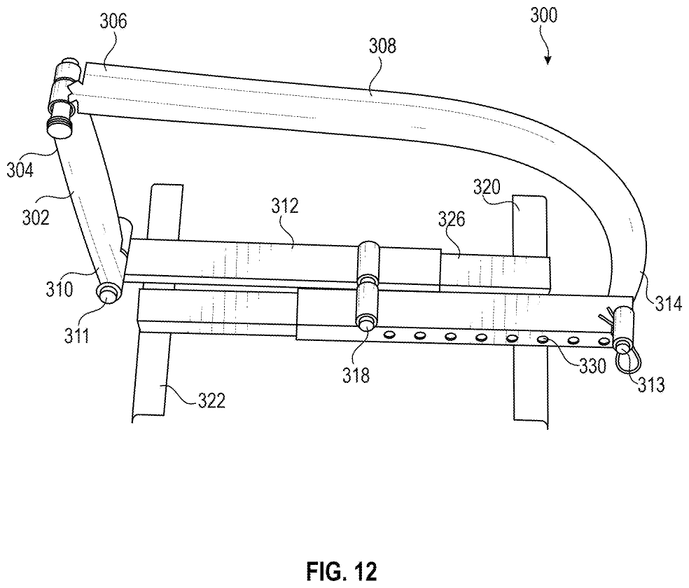

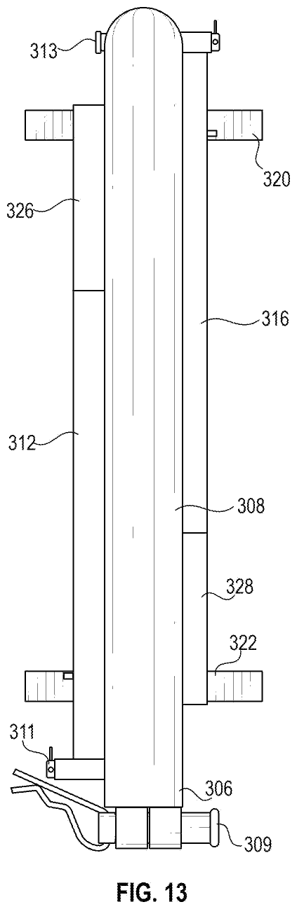

Accordingly, in one method of use, a user would place a first bracket 116 on a first edge of an object, press downwardly on the top 103 of the handle 102, thereby increasing the distance between the first and second brackets 116, 118 until the second bracket 118 engages the second edge of the object. With the first and second brackets 116, 118 on opposite sides of the object, a user may lift up on the top 103 of the handle 102 which causes the brackets 116, 118 to grip the object therebetween. The user may then move the object to the desired location, place the object on the ground/surface, then press downwardly on the top 103 of the handle 102 to increase the distance between the first and second brackets 116, 118, thereby releasing the grip on the object. As a result, a user is able to lift and transport heavy objects without strain. As shown in FIG. 1 (paver stone), FIG. 6 (spool of cable), and FIGS. 12-13 (concrete), a variety of heavy objects may be lifted and maneuvered using a lifting apparatus 100.

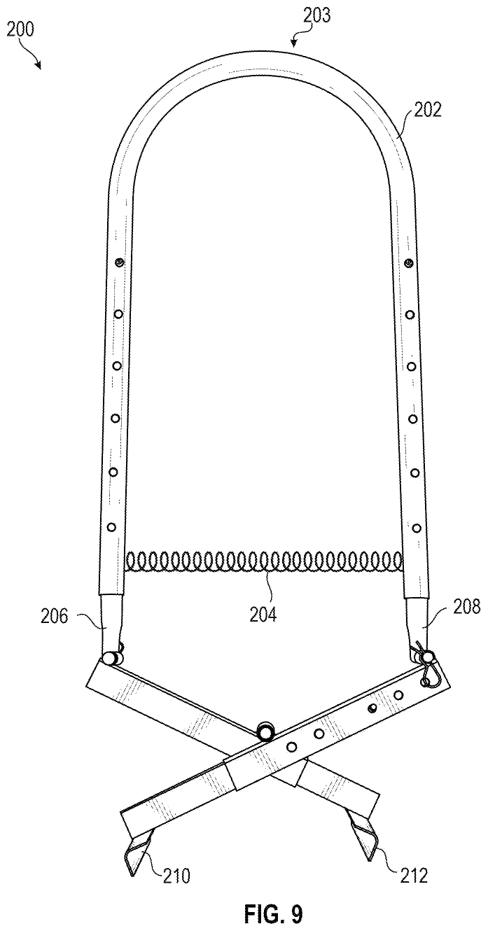

In some embodiments, as shown in FIG. 9, a lifting apparatus 200 comprises a handle 202 and a spring 204 exerting an inward force on a first arm end 206 and a second arm end 208. In other words, the spring 204 may be used to pull the ends 206, 208 inwardly to a first distance. This may be useful when additional inward force is needed to maintain a grip on an object, or for when the handle is made from non-springing materials. A user can extend the spring 204 by pressing downward on the top 203 of the handle 202, which forces the ends 206, 208 outwardly from one another to a second distance wider than the first distance. As the handle 202 is lifted, the spring 204 ensures a tight grip on the object by pulling the ends 206, 208 inwardly, thereby causing the brackets 210, 212 to grip an object therebetween. In another embodiment, not shown, the scissor grip is actuated using a separate lever, which may or may not require a spring.

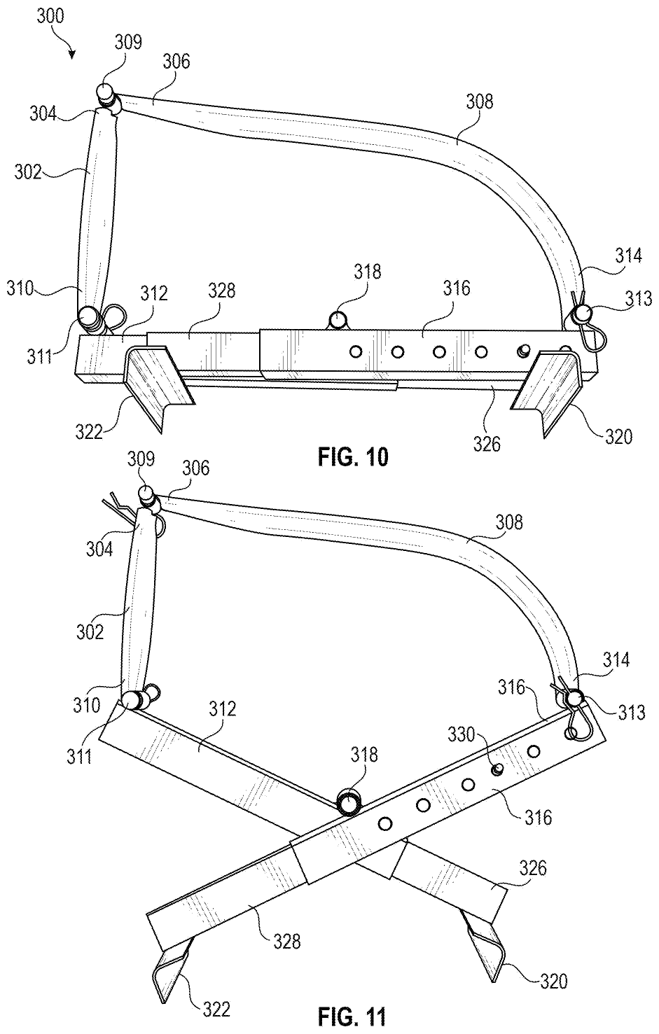

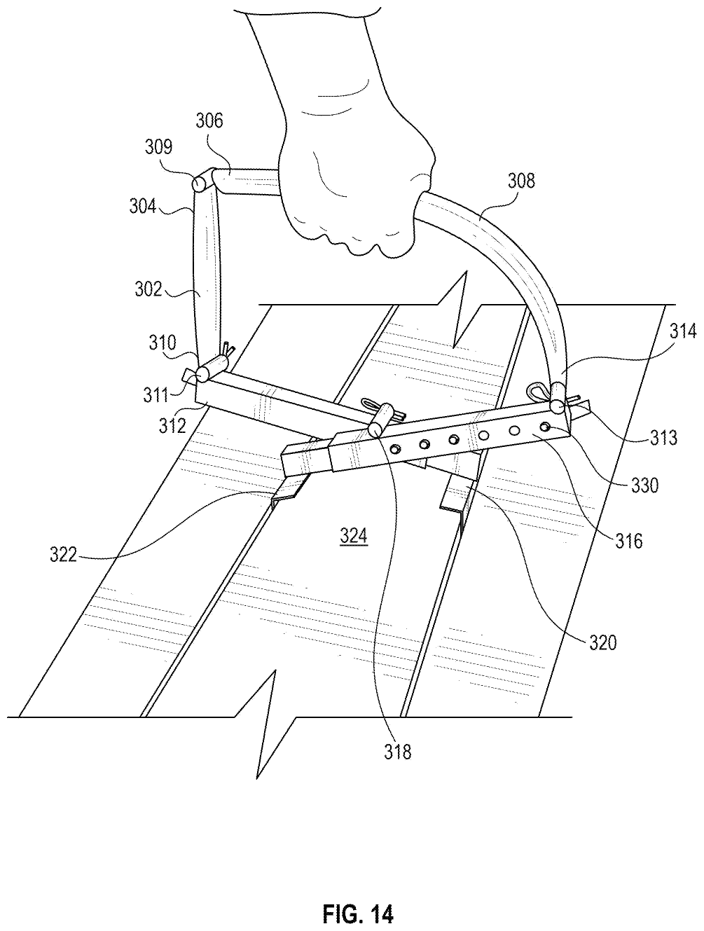

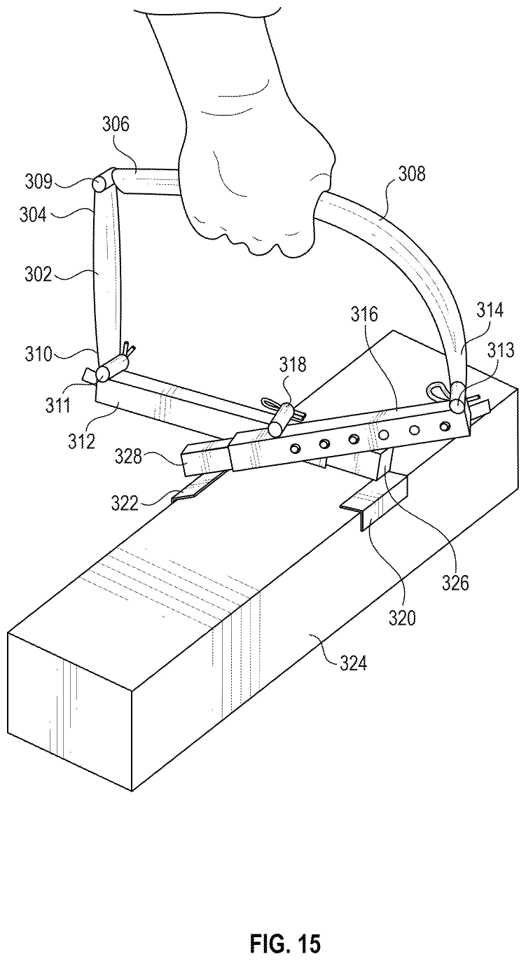

In some embodiments, as shown in FIGS. 10-15, a lifting apparatus 300 comprises a first handle portion 302 hingedly coupled on a first end 304 to a first end 306 of a second handle portion 308, such as via a first hinge pin 309. A second end 310 of the first handle portion 302 is hingedly coupled to a first arm 312, such as via a second hinge pin 311. A second end 314 of the second handle portion 308 is hingedly coupled to a second arm 316, such as via a third hinge pin 313. The first arm 312 pivotally couples to the second arm 316 at a center hinge pin 318. The first arm 312 comprises a first bracket 320 and the second arm comprises a second bracket 322.

In its default position, shown in FIG. 10, the first and second arms 312, 316 are in substantially the same horizontal plane. When a user lifts the second handle portion 308, the weight of the first and second arms 312, 316 cause them to form a “cross” configuration, as shown in FIG. 9. In other words, each hinge point actuates. Accordingly, as shown in FIGS. 12-13, a user may place the first bracket 320 on a first side of an object 324 and the second bracket 322 on an opposite side of the object 324, lift the second handle portion 308, causing the brackets 320, 322 to grip the object 324 therebetween, allowing a user to easily lift the object. This can be particularly beneficial when the space between the object 324 and its surroundings are sufficiently small that fingers are not capable of grasping the object 324. In one non-limiting example, FIGS. 12-13 illustrate a piece of cut concrete (object 324) being lifted and removed.

The first and second arms 312, 316 may be length adjustable so as to adjust to a gripping distance (i.e., the distance between the first bracket 320 and second bracket 322) needed by a user. For example, the first arm 312 may comprise a first telescopic extension arm 326 and the second arm 316 may comprise a second telescopic extension arm 328. In embodiments with a first and second telescopic arm 326, 328, the first bracket 320 is coupled to an end of the first telescopic arm 326 and the second bracket is coupled to an end of the second telescopic arm 328. Therefore, when a user extends the first and/or second telescopic arms 326, 328, the distance between the first bracket 320 and the second bracket 322 increases. When a user retracts the first and/or second telescopic arms 326, 328, the distance between the first bracket 320 and second bracket 322 decreases. Therefore, it will be understood that a user may therefore adjust the gripping distance by adjusting one or more telescopic arms 326, 328. As described in other embodiments, the telescopic arms 326, 328 may be secured into position using spring-loaded pins 330 or other known mechanisms.

Accordingly, the lifting apparatus 100, 200, 300 shown and described herein solves the need in the art for an apparatus that allows a user to easily lift, transport, and place heavy objects without strain or risk of injury to fingers.

It will also be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A lifting apparatus, comprising:
a handle comprising a top, a first end, and a second end;
a first arm hingedly coupled to the first end of the handle;
a second arm hingedly coupled to the second end of the handle;
the first arm pivotally coupled to the second arm via a hinge pin;
a first bracket coupled to an end of the first arm; and
a second bracket coupled to an end of the second arm.

2. The lifting apparatus of claim 1, wherein in a first position, the first end of the handle and the second end of the handle are at a first distance from one another and in a second position the first end of the handle and the second end of the handle are at a second distance from one another, the second distance being less than the first distance.

3. The lifting apparatus of claim 1, wherein the handle is configured to extend telescopically from both the first end of the handle and the second end of the handle.

4. The lifting apparatus of claim 1, wherein the first arm comprises a first telescopic extension arm and the second arm comprises a second telescopic extension arm.

5. The lifting apparatus of claim 4, wherein the first telescopic extension arm and second telescopic extension arm extend outwardly from the first and second arm, respectively.

6. The lifting apparatus of claim 1, further comprising a spring coupled to the first end and the second end of the handle and configured to exert an inward force thereon.

7. A lifting apparatus, comprising:
a first handle portion hingedly coupled on a first end to a first end of a second handle portion;
a second end of the first handle portion hingedly coupled to a first arm;
a second end of the second handle portion hingedly coupled to a second arm;
the first arm pivotally coupled to the second arm via a center hinge pin;
a first bracket coupled to the first arm; and
a second bracket coupled to a second arm.

8. The lifting apparatus of claim 7, wherein in a first position, the first arm and the second arm are in substantially the same horizontal plane and in a second position, the first arm and the second arm form a cross configuration.

9. The lifting apparatus of claim 7, wherein the first and second brackets are configured to receive and grip an object therebetween.

10. The lifting apparatus of claim 7, wherein the first arm comprises a first telescopic extension arm and the second arm comprises a second telescopic extension arm.

11. The lifting apparatus of claim 10, wherein the first telescopic extension arm and second telescopic extension arm extend outwardly from the first and second arm, respectively.

12. A method of using a lifting apparatus, comprising:
placing the lifting apparatus on top of an object to be lifted;
pressing downward on a handle of the lifting apparatus until a first bracket is on a first side of the object and a second bracket is on a second side of the object;
lifting the handle of the lifting apparatus, which causes the first bracket and the second bracket to grip the object therebetween;
moving the object to the desired location; and
pressing downward on the handle to release the grip of the first bracket and the second bracket on the object, thereby releasing the object from the lifting apparatus.

13. The method of claim 12, wherein a user may adjust a gripping distance by telescopically extending a first extension arm from a first arm or a second extension arm from a second arm.
